(19) United States
(12) Patent Application Publication
(10) Pub. No.: US 2018/0018856 A1
(43) Pub. Date: Jan. 18, 2018

(54) ELECTRONIC VARIANT OF THREE-CARD MONTE

(71) Applicant: Mladen Blazevic, New York, NY (US)

(72) Inventor: Mladen Blazevic, New York, NY (US)

(21) Appl. No.: 15/648,321

(22) Filed: Jul. 12, 2017

Related U.S. Application Data
(60) Provisional application No. 62/362,219, filed on Jul. 14, 2016.

(51) Int. Cl. G07F 17/32; A63F 1/14; A63F 1/12; A63F 1/10

(52) U.S. Cl. CPC G07F 17/3288; G07F 17/3293; G07F 17/3248; G07F 17/3246; A63F 1/10; G07F 17/322; A63F 1/14; A63F 1/12; G07F 17/3209

(57) ABSTRACT

A fair variant of Three-card Monte is played with an automatic playing card reading device or an electronic gaming machine. At least three playing cards (or virtual playing cards) are read and randomly placed on a gaming table. One automatically read card is display (without indication of its location) on a display screen. Player wagers are made based on correspondence with properties of the displayed card.

### RELATED APPLICATION DATA

This Application claims priority from U.S. Provisional Patent Application Ser. No. 62/362,219, filed 14 Jul. 2016 and Titled “ELECTRONIC VARIANT OF THREE-CARD MONTE.”

### BACKGROUND OF THE ART

### 1. Field of the Invention

The present invention relates to execution of wagering games using playing cards or playing card symbols performed with an electronic system that enables fair play of types of gaming events that have traditionally required dishonesty or deception to provide an advantage of the house or dealer.

### 2. Background of the Art

Playing cards of various types have been used for centuries to implement wagering events and competitions. Playing cards have generally evolved into what is referred to as a standard playing card deck in which there are 52 playing cards divided into thirteen playing cards each (A, 2, 3, 4, 5, 6, 7, 8, 9, 10, J, Q and K) in four different suits (such as Spades, Hearts, Diamonds and Clubs). One or two Jokers or special cards may also be provided with the basic standard set of 52 playing cards.

Wagering games executed by a dealer, a gaming facility (house) or casino (physical or virtual) have built-in advantages for the house so that honest games can be played with the house still statistically assured of a long range advantage and a profit in providing the wagering game. House advantages in various games and specific wagers may vary between as low as 0.08% to as much as 90%, with jurisdictions often limiting house advantages on individual wagers to amounts such as 20% or 25%.

Some “street games” or carnival games (carny games) can be executed by dealers that manipulate the cards to reduce or even eliminate any probability for the player to win on a wager. One of the more well-known street games has been variations of Three-Card Monte, which can be played with three playing cards, or was originally played with three semicircular shells with a token (ball, pea, etc.) hidden under one of the shells. The dealer rapidly shifts and changes positions of the playing cards or the shells and then offers a player to wager on locating the token under a specific shell or one of the three specific playing cards. The fact that the dealer in these types of street games has practiced physical skills in rapidly altering card positions, moving shell positions and even palming cards or the token enables the dealer to prevent players from winning their wagers even when players believe they have carefully followed the dealer's hand movement of the shells or the playing cards. The fact that the games can be rigged in favor of the dealer has given rise to the common term of “shell game” for any financial activity in which the player is significantly or completely disadvantaged. This type of game has not lent itself to legal commercial operation in gaming facilities because of the reputation for dishonesty in the game, the need for near perfect skill execution by players, the ability of dealers to act in collusion with players against the gaming facility, and other technical issues involved in creating an enjoyable game with a reasonable house advantage.

One attempt at a game in which players attempt to identify locations of specific symbols is the common game of “Concentration” in which multiple pairs of images on playing cards are disposed face down on a surface and players in turn expose two cards from the disposed playing cards, and collecting pairs of cards when the images are identical.

U.S. Pat. No. 6,695,311 (Yu) discloses a game including game pieces and rules for playing a game for a plurality of players, the goal of which is to score the most points by correctly guessing the location of hidden items. The invention provides multiple coverable items, multiple sets of markers, and multiple shells. Multiple coverable items may be hidden under multiple shells in a manner such that multiple sets of markers may be used to guess the location of the corresponding coverable items by stacking a marker onto the corresponding shell.

Many games are now executed on gaming systems which include at least some electronics for assisting wagering or for disclosing images of playing cards during execution of wagering events.

Examples of such electronic wagering events include, but are not limited to systems as shown in U.S. Pat. No. 9,373,220 (Yoseloff); U.S. Pat. Nos. 7,933,444; 6,712,696; 6,688,979; 6,685,568 (Soltys); PCT Applications PCT/US2014/052566 (Blazevic); PCT/US2014/038887 (Blazevic); PCT/US16/029307 (Blazevic) and the like. All patent references cited herein are incorporated by reference in their entirety.

### SUMMARY OF THE INVENTION

A system executes a wagering game using:

a. a gaming table;

b. a storage system for a set of randomly provided playing cards;

c. an automatic playing card reading system which identifies playing cards delivered from the set of randomly provided playing cards according to an order by which the randomly provided playing cards are delivered to the gaming table;

d. positions on the gaming table for receiving the randomly provided playing cards which are delivered to the gaming table;

e. at least one player position at the gaming table;

f. at least one wagering position on the gaming table for receiving wagers on the wagering game;

g. an electronic system associated with the at least one wagering position on the gaming table, the electronic system recognizing at least the presence of a wager at the at least one player position;

h. the automatic playing card reading system identifying at least three playing cards delivered from the set of randomly provided playing cards according to an order of a first playing card, a second playing card and a third playing card by which the randomly provided playing cards are delivered a first playing card position, a second playing card position and a third playing card position to the gaming table;

i. after delivery of the first playing card, the second playing card and the third playing card to their respective first playing card position, second playing card position and third playing card position at the gaming table, the automatic playing card reading system sends a command to a video display visible to the at least one player of a random playing card image randomly selected from the first playing card, the second playing card and the third playing card;

j. the at least one player position indicating by visible signal which of the first playing card, the second playing card and the third playing card matches the random playing card image randomly selected from the first playing card, the second playing card and the third playing card; and

k. the at least one wager resolved by comparing the correspondence of the indication at the player position as to whether the first playing card, the second playing card or the third playing card matches the random playing card image randomly selected.

Exact correspondence between the indication at the player position and the random playing card image randomly selected results in a winning outcome for the at least one player position.

### BRIEF DESCRIPTION OF THE DRAWINGS

While the disclosure concludes with claims particularly pointing out and distinctly claiming embodiments within the scope of the disclosure, various features and advantages of embodiments encompassed by the disclosure may be more readily ascertained from the following description when read in conjunction with the accompanying drawings, in which:

FIG. 1 is a flowchart diagram of a method of administering a wagering game;

FIG. 2 is a diagram of a playing surface for implementation of the wagering game;

FIG. 3 is an enlarged diagram of one of the player positions of the playing surface of FIG. 2;

FIG. 4 is a flowchart diagram of a method of administering a wagering game that may be have at least multiple wagers on a single playing card;

FIG. 5 is a perspective view of an individual electronic gaming device configured for implementation of embodiments of wagering games;

FIG. 6 is a top view of a suitable table configured for implementation of embodiments of wagering games;

FIG. 7 is a perspective view of another embodiment of a suitable table configured for implementation of embodiments of wagering games having a virtual dealer;

FIG. 8 is a schematic block diagram of a gaming system for implementing embodiments of wagering games;

FIG. 9 is a schematic block diagram of a gaming system for implementing embodiments of wagering games including a live dealer feed; and

FIG. 10 is a block diagram of a computer for acting as a gaming system according to one embodiment.

### DETAILED DESCRIPTION OF THE INVENTION

The illustrations presented herein are not meant to be actual views of any particular act in a method of administering a wagering game, apparatus for use in administering a wagering game, or component thereof, but are merely idealized representations employed to describe illustrative embodiments. Thus, the drawings are not necessarily to scale. Additionally, elements common between figures may retain the same or similar numerical designation. Elements with the same number, but including a different alphabet character as a suffix should be considered as multiple instantiations of substantially similar elements and may be referred generically without an alphabet character suffix. For example, elements 100a, 100b, 100c, may be a device that is instantiated three times and referred to generically as element 100.

The terms “gaming,” “gambling,” or the like, refer to activities, games, sessions, rounds, hands, rolls, operations, and other events related to wagering games such as web-based games, casino games, card games, dice games, and other games whose outcome is at least partially based on one or more random events (“chance” or “chances”), and on which wagers may be placed by a player. In addition, the words “wager,” “bet,” “bid,” or the like, refer to any type of wagers, bets or gaming ventures that are placed on random events, whether of monetary or non-monetary value. Points, credits, and other items of value may be purchased, earned, or otherwise issued prior to beginning the wagering game. In some embodiments, purchased points, credits, or other items of value may have an exchange rate that is not one-to-one to the currency used by the user. For example, a wager may include money, points, credits, symbols, or other items that may have some value related to a wagering game. Wagers may be placed in wagering games that are “play for pay” as well as “play for fun,” as will be described in more detail below.

There are at least some generic elements and combinations of elements of play within the scope of the game and technology disclosed. A card game is played only against a pay table. In other embodiments, additional side bets against a dealer hand are played simultaneously with the game against a pay table, as described below. The pay table may be against only a final hand (e.g., correct player-selection of an intended playing card).

A system for executing a wagering game may include:
l. a gaming table; The gaming table may be a physical gaming table (physical cards and physical wagering) or an electronic gaming table (virtual cards and electronic wagering) or a blend of physical cards and electronic wagering.
a storage system for a set of randomly provided playing cards; The storage system may be a cartridge of randomized playing cards, a shuffled set of playing cards, or an electromechanical shuffling device.
an automatic playing card reading system which identifies playing cards delivered from the set of randomly provided playing cards according to an order by which the randomly provided playing cards are delivered to the gaming table; The automatic reading system may be a scanner, a camera, a direct imaging system, a randomized set of playing cards whose order has been previously mapped and entered into or accessed through a code on a container holding the cards, a playing card reader in the shoe or shuffler, a playing card reader on the gaming table that reads individual cards or sets of cards as they are delivered, and the like.
positions on the gaming table for receiving the randomly provided playing cards which are delivered to the gaming table; With exactly three cards, there would be a first position, a second position and a third position, exactly position having only one card placed thereon in a order of first, second and third playing card.
at least one player position at the gaming table;
at least one wagering position on the gaming table for receiving wagers on the wagering game. The wagering position may be an area on the gaming table surface for specific area placement of specific wagers, or an electronic player input panel with buttons and/or touchscreen.
an electronic system associated with the at least one wagering position on the gaming table, the electronic system recognizing at least the presence of a wager at the at least one player position; The wagering position may be an area on the gaming table surface for specific area placement of specific wagers with sensors or cameras indicating the presence of a wager, or an electronic player input panel with buttons and/or touchscreen.
the automatic playing card reading system identifying at least three playing cards delivered from the set of randomly provided playing cards according to an order of a first playing card, a second playing card and a third playing card by which the randomly provided playing cards are delivered a first playing card position, a second playing card position and a third playing card position to the gaming table;
after delivery of the first playing card, the second playing card and the third playing card to their respective first playing card position, second playing card position and third playing card position at the gaming table, the automatic playing card reading system sends a command to a video display visible to the at least one player and a dealer of a random playing card image randomly selected from the first playing card, the second playing card and the third playing card;
m. the at least one player position indicating by visible signal which of the first playing card, the second playing card and the third playing card matches the random playing card image randomly selected from the first playing card, the second playing card and the third playing card; and
the at least one wager resolved by comparing the correspondence of the indication at the player position as to whether the first playing card, the second playing card or the third playing card matches the random playing card image randomly selected,
wherein exact correspondence between the indication at the player position and the random playing card image randomly selected results in a winning outcome for the at least one player position.

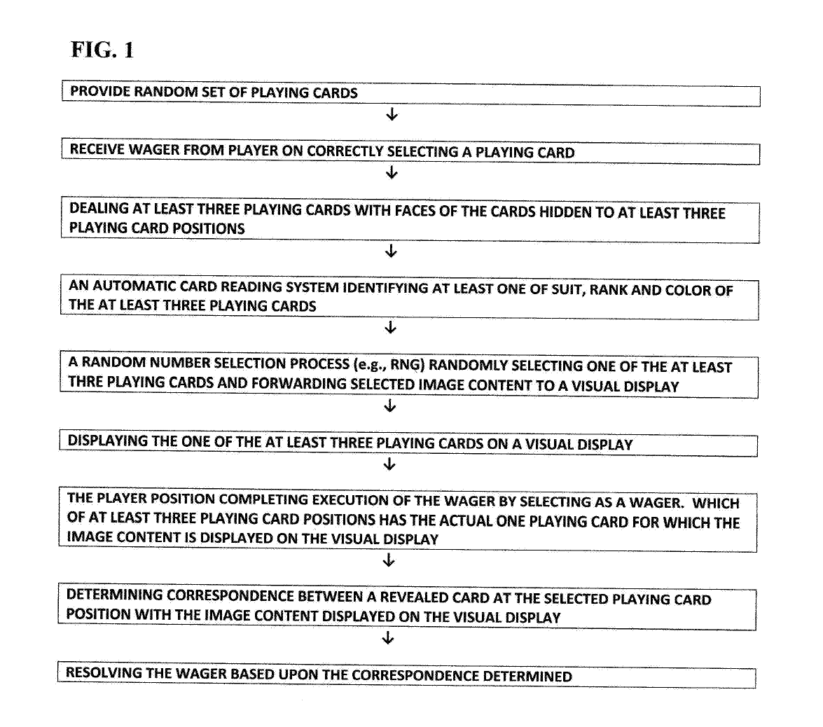

Referring to FIG. 1, a flowchart diagram of a method of administering a wagering game is shown. In game play, according to various embodiments, the players place at least an ante wager (e.g., bonus side bets against a dealer hand and/or jackpot wagers may be separately placed, but need not be compulsory) and receive a set of multiple playing cards such as the exemplified three-card community hand. Community cards are cards dealt and displayed on the table that are used by all players in the construction of intermediate and final hands.

In one embodiment of the wagering game, to initiate play of the game, a dealer or a gaming system receives a wager or an indication of a wager from the player. The table is then provided with a group of at least three community cards. The at least three cards are read before or when placed in their respective first, second or third playing card position. To continue in the hand, the dealer or gaming system receives a play election from the player in the form of a play bet or side wager. The side bet may be equal to the ante bet, or may be a multiple of the ante bet. In this embodiment, additional play bets are made by the player prior to or after the at least one playing card image (the target card) is displayed to the players. After the dealer receives the player's bet, at least one of the first, second and third cards are revealed. By revealing only once playing card, an additional wager (wagering on correspondence of the next card revealed and the target card) can be provided. If no additional wagers are made or are available, all remaining ones of the first, second and third cards are revealed to assure players that the target card is actually on the gaming table. If the hand qualifies as a winning correspondence of selected wager and target card and is listed on the pay table, the player's ante and any side bet are paid based on a payout associated with the difficulty of the correspondence on the pay table. When the player's correspondence or the actual wager is not listed on the pay table, the player's ante and side bet wagers are lost. This is one method of playing the game according to one embodiment. Additional methods and variations of playing a wagering game are further described below.

The game in this example game is played with three initial community cards on the gaming table (e.g., 4 Hearts, Jack Diamonds and King of Spades). In various embodiments, there may then be three, four, or five community cards, with three community cards being the number of cards in this example. The cards are dealt face down after or while being read by a playing card reading system. A random selection process, such as a random number generator or even player selection reveals the suit and rank of a playing card, but not its position on the gaming table. After any additional wagers are made, the playing cards may be revealed one at a time or multiple cards at a time. For example, with three community cards, there could be two correspondence wager when cards are revealed one card at a time, or one play wager on two playing card positions selected to find the target card. After the hand is fully exposed (after the disclosure of all community cards), all wagers are resolved against at least one pay table. There may be a single pay table for all wagers, or different pay tables for each wager. The ante wager may be paid at greater than, equal to or less than 1:1, depending on the probability of the correspondence occurring based on statistics.

Various platforms are contemplated that are suitable for implementation of embodiments of wagering games according to the present disclosure. For example, embodiments of wagering games may be implemented such that one or more players may place wagers and engage in game play according to the rules of the wagering games. For example, wagering games may be implemented on gaming tables, which may include physical gaming features, such as physical cards, physical chips, and may include a live dealer and a shuffler or shoe. More specifically, a live dealer may deal physical cards, accept wagers, issue payouts, and perform other administrative functions of game play, including accepting player game play elections. Some embodiments may be implemented on electronic devices enabling electronic gaming features, such as providing electronic displays for display of virtual cards, virtual chips, game instructions, pay tables, etc. Some embodiments may include features that are a combination of physical and electronic features.

As an example, embodiments of wagering games may be implemented on an individual gaming device for accepting wagers that has a display screen and input devices for enabling game play of the wagering games. Such an individual gaming device may be linked with other gaming devices that may be operated, for example, by other players. Some individual electronic gaming devices may be referred to as an individual player “cabinet” or “terminal” and may be stationary, such as being located on a casino floor. Other individual electronic gaming devices may be portable devices that may be carried to different locations by the player. Portable devices may include both display of the ongoing game play and input reception for game play by a player, and may be configured for receiving input from a player while the game play is displayed on a public monitor, or other display device. Game play and game outcomes may also be displayed on a portable device.

As previously noted, the present games and rules may be played as a live casino table card game, as a hybrid casino table card game (with virtual cards or virtual chips), on a multi-player electronic platform (as disclosed in U.S. patent application Ser. Nos. 10/764,827; 10/764,994, now U.S. Pat. No. 7,661,676, issued Feb. 16, 2010, and Ser. No. 10/764,995, now U.S. Pat. No. 8,272,958, issued Sep. 25, 2012, all filed on Jan. 26, 2004, the disclosure of each of which is incorporated herein in its entirety by this reference), on a personal computer for practice, on a hand-held game for practice or on a legally authorized site on the Internet.

In one embodiment, the players are remotely located from a live dealer and the players observe a live dealer via an electronic camera trained on the dealer and on a game table. Players are able to observe the live dealer on their monitors via a live or prerecorded video feed. In some embodiments, a camera may also be trained on a player, and the players' video feeds may be transmitted to the dealer and also be shared among the players at the table.

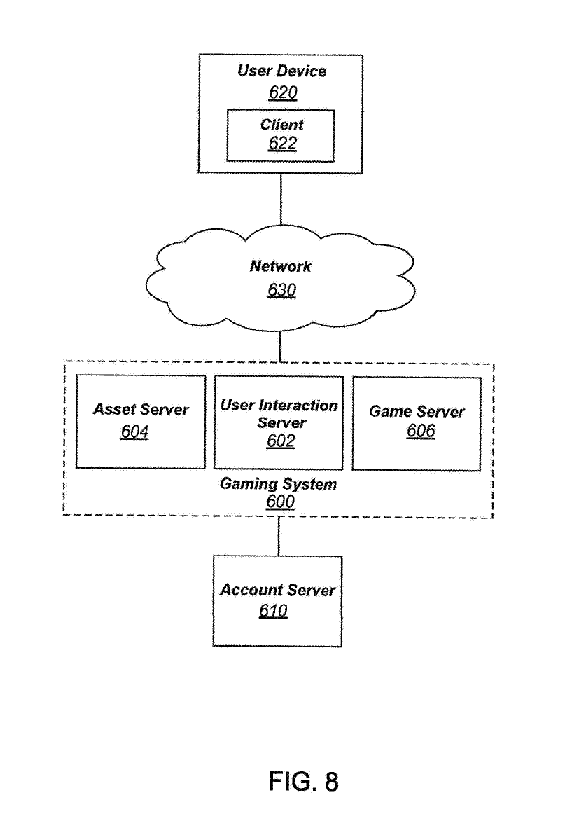

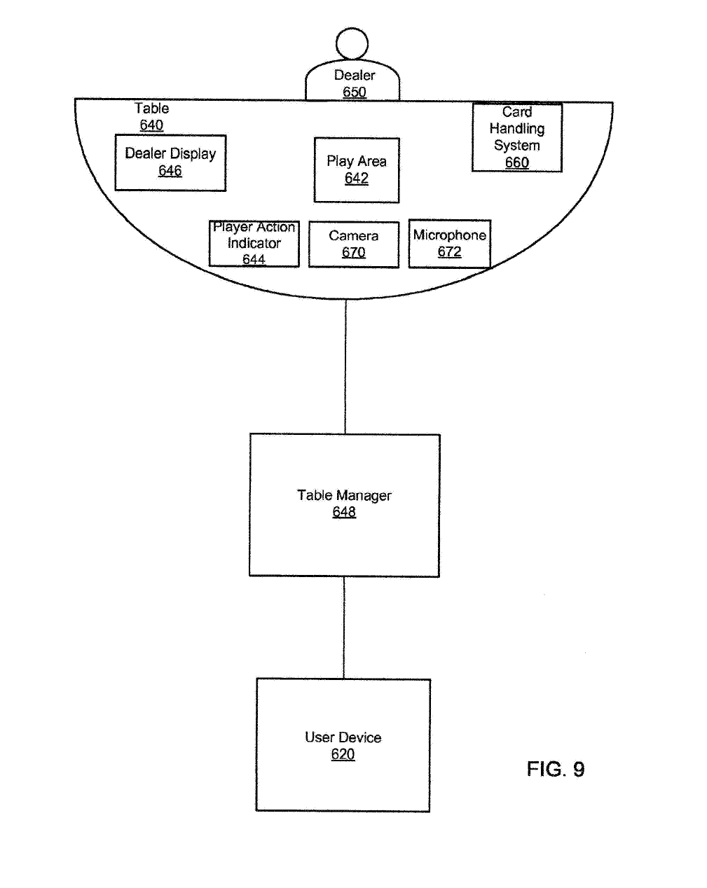

In a sample embodiment, a central station includes a plurality of betting-type game devices, and an electronic camera trained on a dealer. A plurality of player stations are remotely located with respect to the central stations, each of the plurality of player stations including a monitor for displaying a selected game device at the central station, and input means for selecting a game device (such as a live table game operated at a remote location by a live dealer in a studio or remote casino) and for placing a bet by a player at the player's station relating to an action involving an element of chance to occur at the selected game device. Further details on gambling systems and methods for remotely located players are disclosed in U.S. Pat. No. 6,755,741 B1, issued Jun. 29, 2004, and titled “Gambling Game System and Method for Remotely-Located Players,” the disclosure of which is incorporated herein in its entirety by this reference, and in connection with FIGS. 8 and 9.

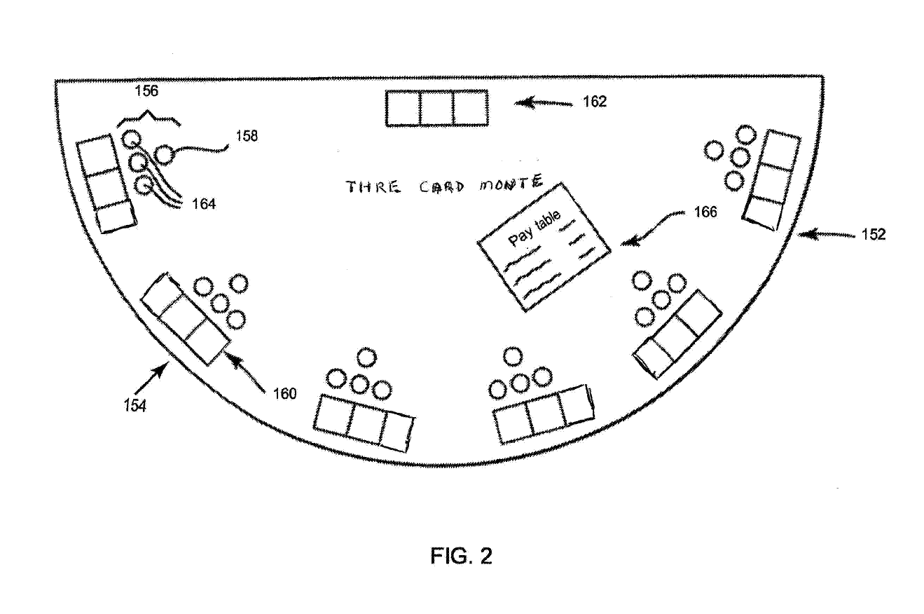

Referring to FIG. 2, a diagram of a playing surface for implementation of the wagering games within the scope of the present disclosure is shown. For purposes of this disclosure, a dealer-administered gaming table with a dealer station, a camera trained on the dealer station, multiple player positions and at least one display for displaying player elections is an exemplary game device. A table layout 152 is shown with an example of six player positions 154, with each player position 154 having a set of wager positions 156 comprising at least an ante wager position 158 and three play bet wager positions 164. Each player position 154 has at least a card receiving area 160 and the dealer position has a community card receiving area 162. Rules of the game and payout tables are shown as an optional area 166. According to the games described above, a player at a player position 154 initially places a wager in the ante wager position 158. Before or after placing the ante wager, the dealer provides cards to the player in card receiving area 162, face down. The player is permitted by the dealer to view the player cards, and makes a first game play election to determine whether to place a first play wager in one of the play bet wager positions 164 or to fold. When community cards are dealt, the community cards are placed at community card receiving area 162, face down at the same time the player cards are dealt to the player card receiving areas 160. In other embodiments, the community cards can be dealt at the time the cards are revealed by the rules of the game.

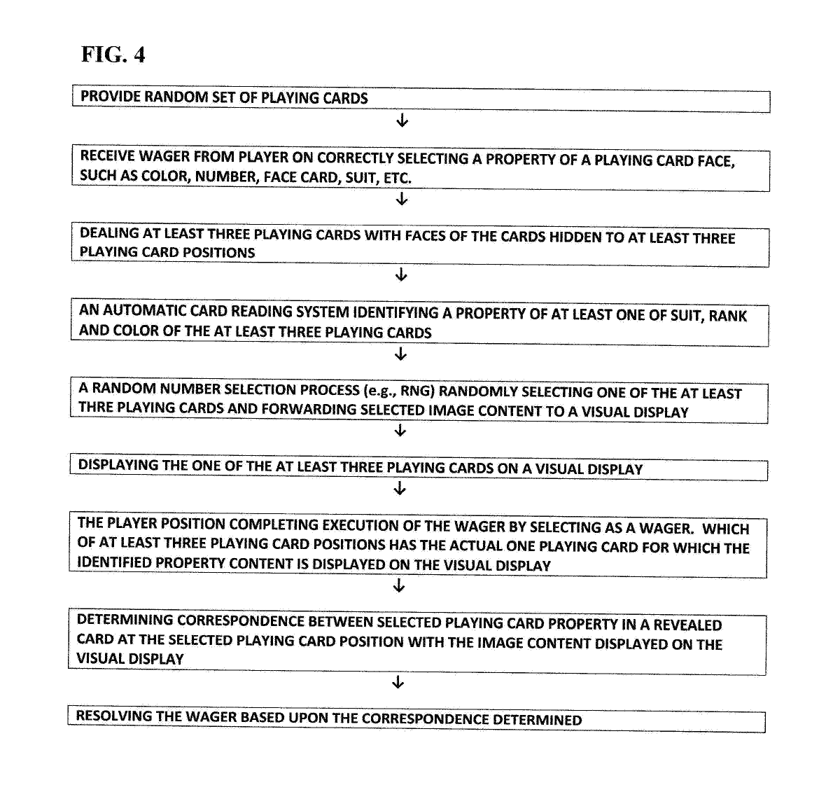

Referring to FIG. 3, an enlarged diagram of one of the player positions 154 of the playing surface of FIG. 2 is shown. A designation of a player position 154 may include a designated frame around the player position 154, as shown in FIG. 3, or may be implied by placement of the wagering areas 156 as shown in FIG. 2. Likewise, the card receiving area 160 may be marked on the table or may not be marked. When a player makes play wagers, the play wagers may be placed from left to right in the play bet wager positions 164. Specifically, a first play wager is placed at play wager position 164a, a second play wager at play wager position 164b, and a third play wager at play wager position 164c. Where more or fewer play wagers are used in a particular embodiment, more or fewer play wager positions may be used. In games where the play wager at each play wager opportunity varies, for example, from the first to the second play wager, or second to third play wager, the separate play wager locations may assist in explicitly indicating which play wager is being placed and the associated amounts available to play at that location.

In some embodiments, the wagering games described herein may be played against the house (i.e., be “house-banked”), which may involve playing against a dealer hand or a pay table, with payouts on wagers being paid by a casino or other gaming establishment and losses on wagers being collected by the casino or other gaming establishment. For example, the ante and play wagers are house banked in one embodiment, such that wins and losses from the player hands are paid from a house account. When a player's hand is paid based on the pay table, the players are paid by the house in this embodiment.

In other embodiments, the wagering games, or at least one wager associated with the wagering game, may enable players to play against one another (i.e., be “player-banked” or “player-pooled”), with payouts on wagers being paid from a pot and losses on wagers being collected by other players. Player-banked games allow a player or a professional banker to take all other player losses and pay payouts to players. In a player-banked version of a game of the present disclosure, a house may provide a dealer to administer the game, and may rake wagers made, payouts won, or charge a flat fee for playing the game. Player-banked games are typically offered as live table games in card rooms where house-banking gaming is not permitted by local gaming regulations. Player-pooled variants of games may be offered as live table games, but are more typically offered in electronic format, where tracking the value of a jackpot pool is conducted using computer-controlled equipment. Player-pooled variants are particularly useful when regulators of online casino play permit the play of “poker.”

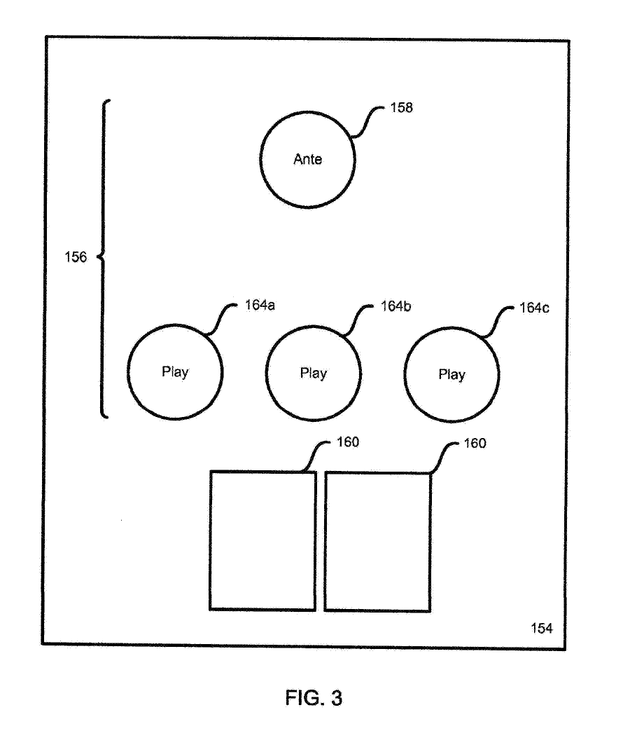

Referring to FIG. 4, a flowchart diagram of a method of administering a wagering game, which may be at least partially player-pooled, is shown. The method might include accepting a first “correspondence” wager from a player and adding the first wager to a first correspondence pot (e.g., a pool or accumulation of bets with its award based on a specific combination of overlapping occurrences wagered on and occurring). The wagers contributed to the poker pool may be raked in one example of the invention.

In some embodiments, a second wager may be a mandatory wager. In other embodiments, a second wager may be optional, and a player wishing to play the poker wagering game may do so by placing a bet in the first pot without placing the second wager and without being eligible to win any award from the second pot. In some embodiments, the second wager may include multiple sub-wagers. For example, the second wager may include an ante wager, a occurrence wager, a second occurrence wager and a third occurrence wager. In other embodiments, a third pot (not shown) for participating in a progressive side bet game is provided. Such third pots may be separate from the other pots, or may be combined with one of the other pots. The second wager may be accepted, for example, by performing any of the acts described previously in connection with FIG. 1.

In some embodiments, the second pot may be a pooled or linked pot. For example, the second pot may include second wagers accepted from multiple concurrent wagering games, which may include only second wagers from those wagering games currently being played or may include accumulated second wagers from past wagering games. As specific, non-limiting examples, the second pot may include all second wagers accepted from a group of tables or local wagering game administration devices at a casino, from multiple groups of remote devices connected to network gaming architecture, or both. In other embodiments, the second pot may not be pooled, and awards for the second wager may be limited to the amounts wagered at a respective table, local wagering game administration device, or group of remote devices.

A rake (e.g., a commission for the house) may be taken on at least one of the first and second wagers. For example, the house may collect a portion of the second wager at the time the second wager is placed or may collect a portion of amounts awarded from the second pot at the time the second pot or a portion of the second pot is awarded. The rake may comprise, for example, a fixed percentage of the second wager. More specifically, the percentage of the second wager collected for the rake may be, for example, greater than a theoretical house advantage for the underlying game. As another example, the rake may be less than an average house advantage for play of the wagering game by all players, including average and sub-average players, which may be calculated using a historical house advantage for the wagering game (e.g., a house advantage for the wagering game over the last 5, 10, or 15 years for a given casino or other gaming establishment). As specific, non-limiting examples, the percentage of the second wager collected for the rake may be between 3% and 8%, between 4% and 7%, or between 5% and 6%. In other embodiments, the portion of the second wager collected for the rake may comprise a variable percentage of the second wager or may comprise a fixed quantity (e.g., a flat fee) irrespective of the total amount for the second wager, a fixed percentage with a cap, or a time-based fee for increments of time playing the wagering game.

All profits for the house may be made from the rake in some embodiments. In such embodiments, all second wagers in excess of the rake may be redistributed back to the players, rather than be collected by the house as additional revenue. Such limiting of profits for the house and redistribution of second wagers back to the players may increase the attractiveness of the wagering game to both inexperienced and highly skilled players. Because the amount earned by the house is known, highly skilled players may perceive that their skill will enable them to increase winnings, and inexperienced players may be enticed by the possibility of winning the second pot or a portion thereof. In other embodiments, the house may make profits on the rake and on losses from one or more of the wagers (e.g., ante and play wagers), including losses resulting from optimal and suboptimal play. The rake may be maintained in a rake account, and profits for the house may be deducted from the rake account. The rake may be taken by, for example, electronically transferring funds from the second pot to a rake account (e.g., as instructed by a game server 606 (see FIG. 8) using casino account servers 610 (see FIG. 8)) or physically removing or exchanging money or representations of money from the second pot on a live table.

A round of the underlying wagering game may be played, as indicated at operation 208. For example, the underlying wagering game may be played at least substantially as described previously in connection with FIGS. 1 through 3. In one embodiment, an additional side wager is played between players, rather than against a pay table. The additional side wager may be a fixed amount, such as an amount equal to the ante bet. The additional side wager is added to a first pot that is completely distributed at the end of each round of play. The distribution of the additional side wager may be based, for example, on the highest three card poker rank from the three community cards. The ante and side bet wagers are added to a second progressive pot for distribution based on the pay table. In this way, the first pot allows the players to compete based on hand strength against other players, while the second pot is able to support larger progressive awards based on a pay table.

Each successive round of making wagers, dealing cards, and resolving wagers may constitute a round of play, and the first pot or a portion of the first pot may be awarded to at least one player at the end of each round of play. The player to whom the first pot or the portion of the first pot is awarded may hold a winning hand or at least a tying hand for that round of play according to the rules of the underlying wagering game. Awarding the first pot or the portion of the first pot may comprise crediting a player account of each wining player or may comprise distributing physical money or physical representations of money to each winning player.

In some embodiments, an entire amount of the first pot may be awarded to at least one player at the end of each round of play. In such embodiments, the first pot may be a non-progressive pot. Awarding the entire first pot to at least one player at the end of each round of play may enable the wagering game to qualify as a legal form of online “correspondence” play under some relevant statutes. For example, in games that require a mandatory pot bet that may or may not be raked, and that has no house advantage, and all other bets go into a second pot that is raked, the game may qualify as “poker” or other specific class of wagering event to gaming authorities, especially for online versions of the games. Awarding the entire amount of a first pot to at least one player at the end of each round of play redistributes lost first wagers attributable to suboptimal play to other players, rather than to the house. Accordingly, such a wagering game may be particularly attractive to players who perceive themselves as being highly skilled in the wagering game and, therefore, more able to take advantage of suboptimal play by other players. In some embodiments, a portion of the first pot may be awarded to at least one player at the end of each round of play. For example, the house may take a rake on the first wager, which may still enable the wagering game to qualify as a legal form of online gambling under some relevant statutes. The rake taken may comprise, for example, between 1% and 8%, between 2% and 6%, or between 3% and 5% of the first wager. The rake amounts on each wager may be more than, less than, or equal to the rake taken on other wagers in some embodiments. In still other embodiments, a portion of the first pot may remain in the first pot or be redistributed to another pot (e.g., the second pot) to be awarded in a subsequent round of play as a progressive payout or a dividend distribution. In such an example, the portion of the wager remaining in the first pot or redistributed to another pot may comprise, for example, a fixed percentage of the first wager, a variable percentage of the first wager (e.g., an odds payout may be awarded and the remainder retained in the first pot or redistributed to the other pot), or a fixed amount.

In lieu of, or in addition to, a rake taken on one or more wagers or from winnings, the house may be compensated in a number of other ways including, without limitation, a flat fee per round of play, a percentage of wagers made with or without a cap, rental of a player “seat,” or otherwise as is known in the gaming art. All such compensation may be generally referred to as a commission.

A premium winning side bet hand composition may comprise, for example, three of a kind, a 3-card straight flush, a 3-card royal flush, or a 3-card royal flush of a certain suit. The hand compositions qualifying as premium winning hand compositions may remain fixed throughout the duration of the wagering game or may change during the wagering game. For example, after a player has achieved a premium winning hand composition, the hand compositions qualifying as premium winning hand compositions may be made more restrictive or less restrictive. As a specific, non-limiting example, after a player has achieved a straight flush, the hand compositions qualifying as premium winning hand compositions may be restricted to royal flushes or may be expanded to include four of a kind. The hands qualifying as premium winning hand compositions may be predetermined at random from a list of possible premium winning hand compositions, following a schedule with a fixed rotation of possible premium winning hand compositions, or according to a fixed table of premium winning hand compositions.

In some embodiments, wagering games may be played without risking money in connection with the wagers (i.e., “play-for-fun” games). Access to play-for-fun wagering games may be granted on a time period basis in some embodiments. For example, upon initially joining the wagering game, each player may automatically be given wagering elements, such as, for example, chips, points, or simulated currency, that is of no redeemable value. After joining, the player may be free to place bets using the wagering elements and a timer may track how long the player has been participating in the wagering game. If the player exhausts his or her supply of the wagering elements before a predetermined period of time has expired, the player may simply wait until the period of time passes to rejoin the game and receive another quantity of the wagering elements to resume participation in the wagering game.

In some embodiments, a player may be permitted to redeem an access token of no redeemable face value, such as, for example, points associated with a player account (e.g., social media account credits, online points associated with a transacting account, casino comping accounts, etc.), to compress the period of time and receive more wagering elements. The access tokens may be purchased or may be obtained without directly exchanging money for the access tokens. For example, access tokens may be acquired by participating in member events (e.g., completing surveys, receiving training on how to play the wagering game, sharing information about the wagering game with others), spending time participating in the wagering game or in a player account forum (e.g., logged in to a social media account), or viewing advertising. Thus, an entity administering play-for-fun wagering games may not receive money from losing player wagers or may not take a rake on wagers, but may receive compensation through advertising revenue or through the purchase of access tokens redeemable for time compressions to continue play of the wagering game or simply to increase the quantity of wagering elements available to a player.

After a player has stopped participating in a play-for-fun wagering game, any remaining quantities of the wagering elements may be relinquished by the player in some embodiments. For example, logging out of a play-for-fun wagering game administered over the Internet may cause any remaining wagering elements associated with a respective player to be lost. Thus, when the player rejoins the play-for-fun wagering game, the quantity of wagering elements given to the player for an allotment of time may not bear any relationship to the quantity of wagering elements held by the player when he or she quit playing a previous session of the wagering game. In other embodiments, the quantity of wagering elements held by a player when stopping participation may be retained and made available to the player, along with any additional quantities of wagering elements granted for new allotments of time, when rejoining the wagering game.

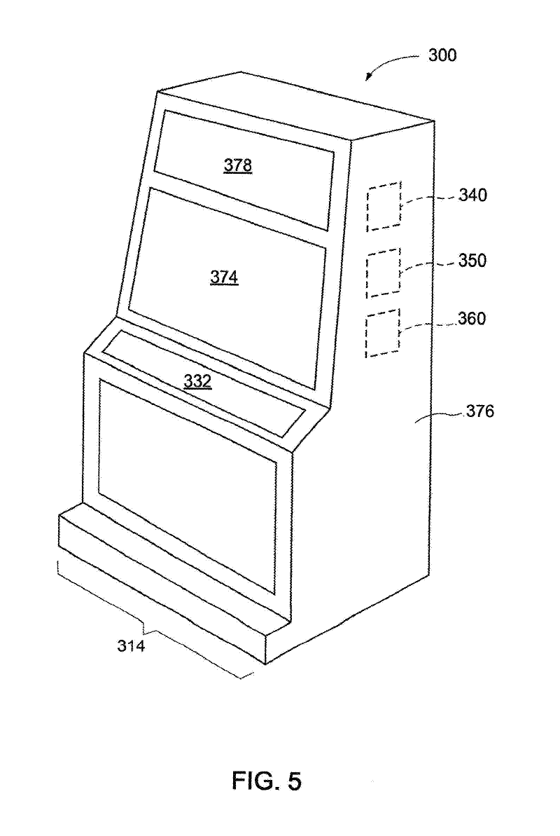

Referring to FIG. 5, an example of an individual electronic gaming device 300 configured for implementation of embodiments of wagering games according to the present disclosure is shown. The individual electronic gaming device 300 may include an individual player position 314 that includes a player input area 332 for a player to interact with the individual electronic gaming device 300 through various input devices (not shown). The electronic gaming device 300 may include a gaming screen 374 configured to display indicia for interacting with the individual electronic gaming device 300, such as through processing one or more programs stored in memory 340 to implement the rules of game play at the individual electronic gaming device 300. Accordingly, game play may be accommodated without involving physical playing cards, poker chips, and/or live personnel. The action may instead be simulated by a control processor 350 operably coupled to the memory 340 and interacting with and controlling the individual electronic gaming device 300. Although gaming device 300 of FIG. 5 has an outline of a traditional gaming cabinet, gaming device 300 may be implemented in any number of ways including, but not limited to, client software downloaded to a portable device, such as a smartphone, tablet, or laptop personal computer. Gaming device 300 may also be a non-portable personal computer (e.g., a desktop or all-in-one computer) or other computing device. In some embodiments, client software is not downloaded but is native to the device, or otherwise delivered with the gaming device 300 when received by a player.

A communication device 360 may be included and operably coupled to the control processor 350 such that information related operation of the gaming device 300, information related to the game play, or combinations thereof may be communicated between the gaming device 300 and other devices (not shown) through a suitable communication media, such as, for example, wired networks, Wi-Fi networks, and cellular communication networks.

The gaming screen 374 may be carried by a generally vertically extending cabinet 376 of the individual electronic gaming device 300. The individual electronic gaming device 300 may further include banners (not shown) configured to communicate rules of game play and/or the like, such as along a top portion 378 of the cabinet 376 of the gaming device 300. The individual electronic gaming device 300 may further include additional decorative lights (not shown), and speakers (not shown) for transmitting and/or receiving sounds during game play. Further detail of an example of an individual electronic gaming device (as well as other embodiments of tables and devices) is disclosed in U.S. patent application Ser. No. 13/215,156, filed Aug. 22, 2011, and titled “Methods of Managing Play of Wagering Games and Systems for Managing Play of Wagering Games,” the disclosure of which is incorporated herein in its entirety by this reference.

Some embodiments may be implemented at locations that include a plurality of player stations. Such player stations may include an electronic display screen for display of game information, such as displaying virtual cards, virtual chips, and game instructions, and for accepting wagers and facilitating credit balance adjustments. Such player stations may, optionally, be integrated in a table format, may be distributed throughout a casino or other gaming site, or may include both grouped and distributed player stations. While some features may be automated through electronic interfaces (e.g., virtual cards, virtual chips, etc.), some features may remain in the physical domain. As such, the game play may be administered by a live dealer, a virtual dealer, or a combination of both.

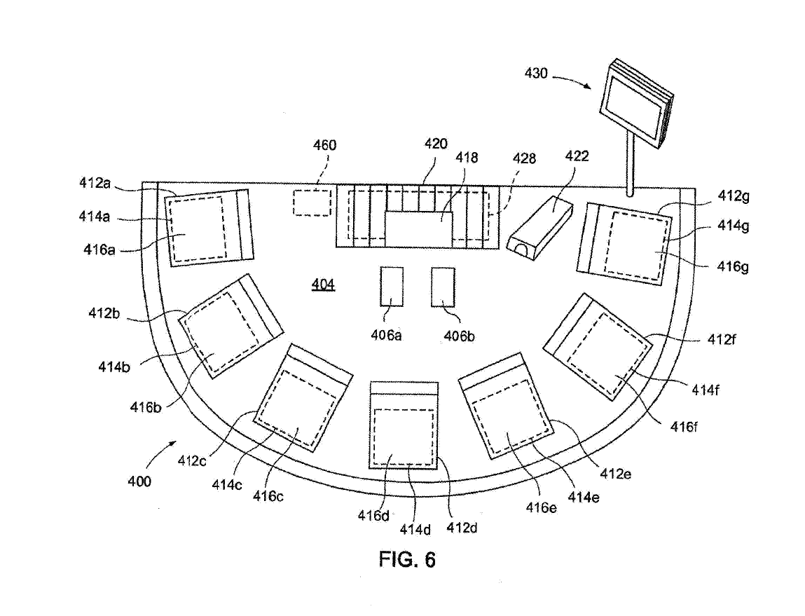

Referring to FIG. 6, an example of a suitable table 400 configured for implementation of embodiments of wagering games according to the present disclosure is shown. The table 400 may include a playing surface 404. The table 400 may include a plurality of player stations 412a through 412g. Each player station 412a through 412g may include a player interface 416a through 416g, which may be used for displaying game information (e.g., game instructions, input options, wager information including virtual chips, game outcomes, etc.). The player interface 416a through 416g may include a display screen in the form of a touch screen, which may be at least substantially flush with the playing surface 404 in some embodiments. Each player interface 416a through 416g may be coupled respectively with its own local game processor 414a through 414g (shown in dashed lines), although in some embodiments, a central game processor 428 (shown in dashed lines) may be employed and communicate directly to player interfaces 416a through 416g. In some embodiments, a combination of individual local game processors 414a through 414g and a central game processor 428 may be employed.

A communication device 460 (shown in dashed lines) may be included and operably coupled to one or more of the local game processors 414, the central game processor 428, or combinations thereof, such that information related operation of the table 400, information related to the game play, or combinations thereof may be communicated between the table 400 and other devices (not shown) through a suitable communication media, such as, for example, wired networks, Wi-Fi networks, and cellular communication networks.

The table 400 may further include additional features, such as a dealer chip tray 420, which may be used by the dealer to cash players in and out of the wagering game, whereas wagers and balance adjustments during game play may be performed using virtual chips. For embodiments using physical cards 406a and 406b, the table 400 may further include a card handling device 422 that may be configured to shuffle, read, and deliver physical cards for the dealer and players to use during game play or, alternatively, a card shoe configured to read and deliver cards that have already been randomized. For embodiments using virtual cards, such virtual cards may be displayed at the individual player interfaces 416a through 416g. Common virtual cards may be displayed in a common card area (not shown).

The table 400 may further include a dealer interface 418, which, like the player interfaces 414a through 414g, may include touch screen controls for assisting the dealer in administering the wagering game. The table 400 may further include an upright display 430 configured to display images that depict game information such as pay tables, hand counts, historical win/loss information by player, and a wide variety of other information considered useful to the players. The upright display 430 may be double-sided to provide such information to players as well as to the casino pit.

Further detail of an example of a table and player displays is disclosed in U.S. Patent Application Pub. No. 2010/0016050, filed Jul. 15, 2008, and titled “Split Screen on a Chipless Gaming Table,” the disclosure of which is incorporated herein in its entirety by this reference. Although an embodiment is described showing individual discrete player stations, in some embodiments, the entire playing surface 404 may be an electronic display that is logically partitioned to permit game play from a plurality of players for receiving inputs from, and displaying game information to, the players, the dealer, or both.

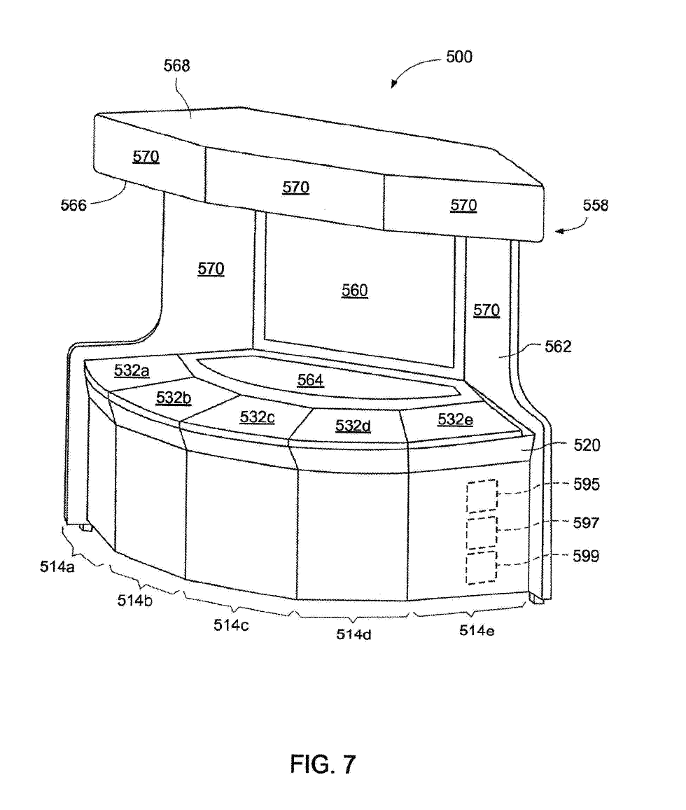

Referring to FIG. 7, another example of a suitable table 500 configured for implementation of embodiments of wagering games having a virtual dealer according to the present disclosure is shown. The table 500 may include player positions 514a through 514e that are arranged in a bank about an arcuate edge 520 of a video device 558 that may comprise a card screen 564 and a dealer screen 560. The dealer screen 560 may display a video simulation of the dealer (i.e., a virtual dealer) for interacting with the video device 558, such as through processing one or more stored programs stored in memory 595 to implement the rules of game play at the video device 558. The dealer screen 560 may be carried by a generally vertically extending cabinet 562 of the video device 558. The card screen 564 may be configured to display at least one or more of the dealer's cards, community cards, and/or player's cards by the virtual dealer on the dealer screen 560 (virtual dealer not shown in FIG. 7).

Each of the player positions 514a through 514e may include a player interface area 532a through 532e, which is configured for wagering and game play interactions with the video device 558 and/or virtual dealer. Accordingly, game play may be accommodated without involving physical playing cards, poker chips, and/or live personnel. The action may instead be simulated by a control processor 597 interacting with and controlling the video device 558. The control processor 597 may be located internally within, or otherwise proximate to, the video device 558. The control processor 597 may be programmed, by known techniques, to implement the rules of game play at the video device 558. As such, the control processor 597 may interact and communicate with display/input interfaces and data entry inputs for each player interface area 532a through 532e of the video device 558. Other embodiments of tables and gaming devices may include a control processor that may be similarly adapted to the specific configuration of its associated device.

A communication device 599 may be included and operably coupled to the control processor 597 such that information related to operation of the table 500, information related to the game play, or combinations thereof may be communicated between the table 500 and other devices (not shown) through a suitable communication media, such as, for example, wired networks, Wi-Fi networks, and cellular communication networks.

The video device 558 may further include banners (not shown) configured to communicate rules of play and/or the like, which may be located along one or more walls 570 of the cabinet 562. The video device 558 may further include additional decorative lights (not shown) and speakers (not shown), which may be located on an underside surface 566, for example, of a generally horizontally depending top 568 of the cabinet 562 of the video device 558 generally extending toward the player positions 514a through 514e.

Further detail of an example of a table and player displays is disclosed in U.S. Patent Application Pub. No. 2005/0164762, filed Jan. 26, 2004, and titled “Automated Multiplayer Game Table with Unique Image Feed of Dealer,” the disclosure of which is incorporated herein in its entirety by this reference. Although an embodiment is described showing individual discrete player stations, in some embodiments, the entire playing surface (e.g., player interface areas 532a through 532e, card display 564, etc.) may be an electronic display that is logically partitioned to permit game play from a plurality of players for receiving inputs from, and displaying game information to, the players, the dealer, or both.

Wagering games, in accordance with embodiments of the disclosure, may be administered over the Internet, or otherwise online, in one embodiment using a gaming system employing a client server architecture. Referring to FIG. 8, a schematic block diagram of a gaming system 600 for implementing wagering games according to an embodiment is shown. The gaming system 600 enables end users to access proprietary and/or non-proprietary game content. Such game content may include, without limitation, various types of wagering games such as card games, dice games, big wheel games, roulette, scratch off games (“scratchers”), and any other wagering game where the game outcome is determined, in whole or in part, by one or more random events. This includes, but is not be limited to, Class II and Class III games as defined under 25 U.S.C. .sctn.2701 et seq. (“Indian Gaming Regulatory Act”). Such games may include banked and/or non-banked games.

The wagering games supported by the gaming system 600 may be operated with real currency or with virtual credits or other virtual (e.g., electronic) value indicia. For example, the real currency option may be used with traditional casino and lottery-type wagering games in which money or other items of value are wagered and may be cashed out at the end of a game session. The virtual credits option may be used with wagering games in which credits (or other symbols) may be issued to a player to be used for the wagers. A player may be credited with credits in any way allowed including, but not limited to, a player purchasing credits, being awarded credits as part of a contest or a win event in this or another game (including non-wagering games), being awarded credits as a reward for use of a product, casino or other enterprise, time played in one session, games played, or may be as simple as virtual credits upon logging in at a particular time or with a particular frequency, etc. Although credits may be won or lost, the ability of the player to cash out credits may be controlled or prevented. In one example, credits acquired (e.g., purchased or awarded) for use in a play-for-fun game may be limited to non-monetary redemption items, awards, or credits usable in the future or for another game or gaming session. The same credit redemption restrictions may be applied to some or all of credits won in a wagering game as well. Preferably, the electronic gaming machine or other electronic gaming formats (table top games, banked games, electronic gaming table) may have a housing, player input control, video display including touchscreen sensitivity, processor, memory, and a value-in-value-out credit creation component selected from the group consisting of a) a ticket-in-ticket-out system having a ticket-reading scanner and ticket printer, b) a currency validation system having a motor drive to advance currency past a scanner, and c) a near field communication system comprising a sensor in the gaming system and a readable card, tag or key that can communicatively interact with the sensor in the gaming table.

An additional variation includes web-based sites having both play-for-fun and wagering games, including issuance of free (non-monetary) credits usable to play the play-for-fun games. This may attract players to the site and to the games before they engage in wagering. In some embodiments, a limited number of free or promotional credits may be issued to entice players to play the games. Another method of issuing credits includes free credits in exchange for identifying friends who may want to play. In another embodiment, additional credits may be issued after a period of time has elapsed to encourage the player to resume playing the game. The system may enable players to buy additional game credits to allow the player to resume play. Objects of value may be awarded to play-for-fun players, which may or may not be in a direct exchange for credits. For example, a prize may be awarded or won for a highest scoring play-for-fun player during a defined time interval. All variations of credit redemption are contemplated, as desired by game designers and game hosts (the person or entity controlling the hosting systems).

The gaming system 600 may include a gaming platform that establishes a portal for an end user to access a wagering game hosted by a game server 606 through a user interaction server 602. A user device 620 may communicate with a user interaction server 602 of the gaming system 600 using a network 630 (e.g., the Internet). The user interaction server 602 may communicate with the game server 606 and provide game information to the user. In some embodiments, the game server 606 may also be a game engine. In some embodiments, a single user device 620 communicates with a game provided by the game server 606, while other embodiments may include a plurality of user devices 620 configured to communicate and provide end users with access to the same game provided by the game server 606. In addition, a plurality of end users may access a single user interaction server 602, or a plurality of user interaction servers 602, to access game server 606.

The user interaction server 602 may communicate with the user device 620 to enable access to the gaming system 600. The user interaction server 602 may enable a user to create and access a user account and interact with gaming server 606. The user interaction server 602 may enable users to initiate new games, join existing games, and interface with games being played by the user.

The user interaction server 602 may also provide a client 622 for execution on the user device 620 for accessing the gaming system 600. The client 622 provided by the gaming system 600 for execution on the user device 620 can comprise a variety of implementations according to the user device 620 and method of communication with the gaming system 600. In one embodiment, the user device 620 connects to the gaming system 600 using a web browser and the client 622 executes within a browser window or frame of the web browser. In another embodiment, the client 622 is a stand-alone executable on the user device 620.

In one embodiment, the client 622 may comprise a relatively small amount of script (e.g., JAVASCRIPT®), also referred to as a “script driver,” including scripting language that controls an interface of the client 622. The script driver may include simple function calls requesting information from the gaming system 600. In other words, the script driver stored in the client 622 may merely include calls to functions that are externally defined by, and executed by, the gaming system 600. As a result, the client 622 may be characterized as a “thin client.” As that term is used herein, the client 622 may be little more than a script player. The client 622 may simply send requests to the gaming system 600 rather than performing logic itself. The client 622 receives player inputs and the player inputs are passed to gaming system 600 for processing and executing the wagering game. In one embodiment, this includes providing specific graphical display information to client 622, as well as game outcomes.

In other embodiments, the client 622 comprises an executable file rather than a script. In that case, client 622 may do more local processing than does a script driver, such as calculating where to show what game symbols upon receiving a game outcome from game server 606 through user interaction server 602. In one embodiment, it may be that portions of asset server 604 are loaded onto the client 622, and used by the client 622 in processing and updating graphical displays. Due to security and integrity concerns, most embodiments will have the bulk of the processing of the game play performed in the gaming system 600. However, some embodiments may include significant game processing by client 622 when the client and user device 620 are considered trustworthy or when there is reduced concern for security and integrity in the displayed game outcome. In most embodiments, it is expected that some form of data protection, such as end-to-end encryption, will be used when data is transported over network 630. Network 630 may be any network including, but not limited to, the Internet.

In an embodiment where the client 622 implements further logic and game control methodology beyond a thin client, the client 622 may parse and define player interactions prior to passing the player interactions to the gaming system 600. Likewise, when the client 622 receives a gaming interaction from the gaming system 600, the client 622 may be configured to determine how to modify the display as a result of the gaming interaction. The client 622 may also allow the player to change a perspective or otherwise interact with elements of the display that do not change aspects of the game.

In one form of the invention, the client 622 is part of an online casino that enables game play on gaming system 600 by players playing on the user device 620. The client 622 provides a portal to the gaming system 600 and the player may not be aware that a game that is being played on the online casino is being administered by the gaming system 600. In other embodiments, the gaming system 600 is an integral part of the online casino. In other embodiments, the gaming system 600 is operated by a different entity than the entity that operates the online casino.

The gaming system 600 may include an asset server 604, which may host various media assets (e.g., audio, video, and image files) that may be sent to the client 622 for presenting the various wagering games to the end user. In other words, in this embodiment the assets presented to the end user may be stored separately from the client 622. In one embodiment, the client 622 requests the assets appropriate for the game played by the user; in other embodiments, especially those using thin clients, just those assets that are needed for a particular display event will be sent by game server 600 when the game server 600 determines they are needed, including as few as one asset. In one example, the client 622 may call a function defined at the user interaction server 602 or asset server 604, which may determine which assets are to be delivered to the client 622, as well as how the assets are to be presented by the client 622 to the end user. Different assets may correspond to the various clients that may have access to the game server 606 or to different games to be played.

The game server 606 is configured to perform game play methods and determine game play outcomes that are provided to the user interaction server 602 to be transmitted to user device 620 for display on the end user's computer. For example, the game server 606 may include game rules for one or more wagering games, such that the game server 606 controls some or all of the game flow for a selected wagering game, as well as determining game outcomes. Game server 606 may include pay tables and other game logic. The game server 606 also performs random number generation for determining random game elements of the wagering game. In one embodiment, the game server 606 is separated from the user interaction server 602 by a firewall or other method of preventing unauthorized access to the game server 606 from the general members of the network 630.

The user device 620 may present a gaming interface to the player and communicate the user interaction to the gaming system 600. The user device 620 may be any electronic system capable of displaying gaming information, receiving user input, and communicating the user input to the gaming system 600. As such, the user device 620 can be a desktop computer, a laptop, a tablet computer, a set-top box, a mobile device including, but not limited to, smartphones, a kiosk, a terminal, or another computing device. The user device 620 may operate the client 622. When the user device 620 operates the client 622, the user device 620 may comprise an interactive electronic gaming system 300 (see FIG. 5), as described above. The client 622 may be a specialized application or may be executed within a generalized application capable of interpreting instructions from the interactive gaming system 600, such as a web browser.

The client 622 may interface with an end user through a web page, or an application that runs on a device including, but not limited to, a smartphone, a tablet, or a general computer, or be any other computer program configurable to access the gaming system 600. The client 622 may be illustrated within a casino webpage (or other interface) indicating that the client 622 is embedded into a webpage, which is supported by a web browser executing on the user device 620.

In one embodiment, the gaming system 600 may be operated by different entities. The user device 620 and/or device housing the client 622 may be operated by a third party, such as a casino or an individual, that links to the gaming system 600, which may be operated, for example, by a wagering game service provider. Therefore, in some embodiments, the user device 620 and client 622 may be operated by a different administrator than the operator of the game server 606. In other words, the user device 620 may be part of a third-party system that does not administer or otherwise control the gaming system 600 or game server 606. In another embodiment, the user interaction server 602 and asset server 604 are provided by a third-party system. For example, a gaming entity (e.g., a casino) may operate the user interaction server 602 or user device 620 to provide its customers access to game content managed by a different entity, which may control game server 606, amongst other functionality. In some embodiments, these functions are operated by the same administrator. For example, a gaming entity (e.g., a casino) may elect to perform each of these functions in-house, such as providing both the access to the user device 620 and the actual game content and providing administration of the gaming system 600.

The gaming system 600 may communicate with one or more external account servers 610, optionally through another firewall. For example, the gaming system 600 itself may not directly accept wagers or issue payouts. That is, the gaming system 600 may facilitate online casino gaming, but may not be part of a self-contained online casino itself. Instead, the gaming system 600 may facilitate the play of wagering games owned and controlled by a company offering games and gaming products and services, such as SHFL entertainment, Inc. Another entity (e.g., a casino or any account holder or financial system of record) may operate and maintain its external account servers 610 to accept bets and make payout distributions. The gaming system 600 may communicate with the account servers 610 to verify the existence of funds for wagering, and instruct the account server 610 to execute debits and credits.

In some embodiments, the gaming system 600 may directly accept bets and make payout distributions, such as in the case where an administrator of the gaming system 600 operates as a casino. As discussed above, the gaming system 600 may be integrated within the operations of a casino rather than separating out functionality (e.g., game content, game play, credits, debits, etc.) among different entities. In addition, for play-for-fun wagering games, the gaming system 600 may issue credits, take bets, and manage the balance of the credits according to the game outcomes, but may not permit payout distributions or be linked to an account server 610 that permits payout distributions. Such credits may be issued for free, through purchase, or for other reasons, without the ability for the player to cash out. Such play-for-fun wagering games may be played on platforms that do not permit traditional gambling, such as to comply with jurisdictions that do not permit online gambling.

The gaming system 600 may be configured in many ways, from a fully integrated single system to a distributed server architecture. The asset server 604, user interaction server 602, game server 606, and account server 610 may be configured as a single, integrated system of code modules running on a single server or machine, where each of the servers is functionally implemented on a single machine. In such a case, the functionality described herein may not be implemented as separate code modules. The asset server 604, user interaction server 602, game server 606, and account server 610 may also be implemented as a plurality of independent servers, each using its own code modules running on a separate physical machine, and may further include one or more firewalls between selected servers (depending on security needs). Each server could communicate over some kind of networked connection, potentially as varied as that described for network 630. Further, each single server shown in FIG. 8 may be implemented as a plurality of servers with load balancing and scalability factors built into the embodiment. All such embodiments and variations are fully contemplated.

Additional features may be supported by the game server 606, such as hacking and cheating detection, data storage and archival, metrics generation, messages generation, output formatting for different end user devices, as well as other features and operations. For example, the gaming system 600 may include additional features and configurations as described in U.S. patent application Ser. No. 13/353,194, filed Jan. 18, 2012, and U.S. patent application Ser. No. 13/609,031, filed Sep. 10, 2012 both titled “Network Gaming Architecture, Gaming Systems, and Related Methods,” the disclosures of which are incorporated herein in their entirety by this reference.

The network 630 may enable communications between the user device 620 and the gaming system 600. A network (not shown) may also connect the gaming system 600 and account server 610, and, further, one or more networks (not shown) may interconnect one or more of the other servers shown collectively as game system 600. In one embodiment, the network 630 uses standard communications technologies and/or protocols. Thus, the network 630 can include links using technologies such as Ethernet, 802.11, worldwide interoperability for microwave access (WiMAX), 3G, digital subscriber line (DSL), asynchronous transfer mode (ATM), INFINIBAND®, PCI Express Advanced Switching, etc. Similarly, the networking protocols used on the network 630 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 630 can be represented using technologies and/or formats including the hypertext markup language (HTML), the extensible markup language (XML), etc. In addition, all or some of the links can be encrypted using conventional encryption technologies such as secure sockets layer (SSL), transport layer security (TLS), virtual private networks (VPNs), Internet Protocol security (IPsec), etc. In another embodiment, the entities can use custom and/or dedicated data communications technologies instead of, or in addition to, the ones described above. Depending upon the embodiment, the network 630 can include links comprising one or more networks such as the Internet.

FIG. 9 is a schematic block diagram of a gaming system for implementing embodiments of wagering games including a live dealer feed. Features of the gaming system 600 as described above (see FIG. 8) are generally implemented by this embodiment, except as further described. In this embodiment, rather than cards being determined by a computerized random process, cards are dealt by a dealer 650 at a table 640 from a card handling system 660. A table manager 648 assists the dealer 650 in facilitating play of the game by transmitting a video feed of the dealer's actions to the user device 620 and transmitting player elections to the dealer 650. As described above, the table manager 648 communicates with a gaming system 600 to provide gaming at table 640 to users of the gaming system 600. Thus, the table manager 648 communicates with the user device 620 through a network, and may be a part of a larger online casino, or may be operated as a separate system that facilitates game play. In various embodiments, each table 640 is managed by an individual table manager 648 constituting a gaming device, which receives and processes information relating to that table. For simplicity of description, these functions are described as being performed by the table manager 648, though certain functions may be performed by an intermediary gaming system 600. In some embodiments, the gaming system 600 may match players to tables 640 and facilitate transfer of information between user devices and gaming devices, such as wagering amounts and player action elections, but does not manage gameplay at individual tables. In other embodiments, functions of the table manager 648 are incorporated into a gaming system 600.

The table 640 includes a camera 670 and optionally a microphone 672 that capture video and audio feeds relating to the table 640. The camera 670 is trained on the dealer 650, play area 642, and card handling system 660. As the game is administered by the dealer 650, the player using the user device 620 is shown the video feed captured by the camera 670 and any audio captured by the microphone 672.

The card handling system 660 is typically a shuffling device, though the card handling system 660 may also be a shoe for dispensing cards. When the game play rules require cards to be dealt, the dealer 650 obtains a card from the card handling system 660 and places the card in the appropriate location in a play area 642. The play area 642 depicts player positions and any applicable card locations for playing the same, such as shown in FIGS. 2 and 3. As determined by the rules of the game, the player at the user device 620 is presented options for responding to an event in the game using a client 622, as described with reference to FIG. 8.

The user device 620 presents the options to the player and permits the player to select an election from among the options. The election is transmitted to the table manager 648, which provides player elections to the dealer 650 using a dealer display 646 and player action indicator 644 on the table 640. The dealer display 646 and player action indicator 644 provide information to the dealer 650 regarding the game play and elections made by players. Using the dealer display 646, for example, the dealer 650 may obtain information regarding where to deal the next card, or which player position is responsible for the next action.

In one embodiment, the table manager 648 receives card information from the card handling system 660 describing cards dealt by the card handling system 660. The card handling system 660 may include a card reader that determines card information from the card. For example, the card handling system 660 may process an image of the card, or the card handling system 660 may include a barcode reader or other system for obtaining information regarding each card. The card information may include rank and suit of each dealt card, which is obtained by the card handling system 660 and transmitted to the table manager 648. The card handling system 660 may also dispense more than one card at once, or identify a set of cards dispensed together as a hand. One example card handling system 660 is described in U.S. Pat. No. 8,070,574, which is hereby incorporated by reference.

Using the card information, the table manager 648 identifies hands associated with each player and, when applicable, the dealer. The table manager 648 uses the card information and identified hands, along with the elected player decisions, to determine gameplay events and, using the rules of the game, determine wager results. Alternatively, the wager results are determined by the dealer 650 and input to the table manager 648, and may be used to confirm automatically determined results by the gaming system. Optionally, the card information relating to cards viewable by a player is also transmitted to the user device 620 associated with the player, permitting representations of the cards to be displayed to the user in addition to the cards viewed in the play area 642.

The live video feed permits the dealer 650 to show cards dealt by the card handling system and play the game as though the player were at a live casino. In addition, the dealer 650 can prompt a user by announcing a player's election is to be performed. In embodiments where a microphone 672 is included, the dealer 650 can verbally announce action or request an election by a player. In some embodiments, the user device 620 also includes a camera or microphone, which also captures feeds to be shared with the dealer 650 and other players.

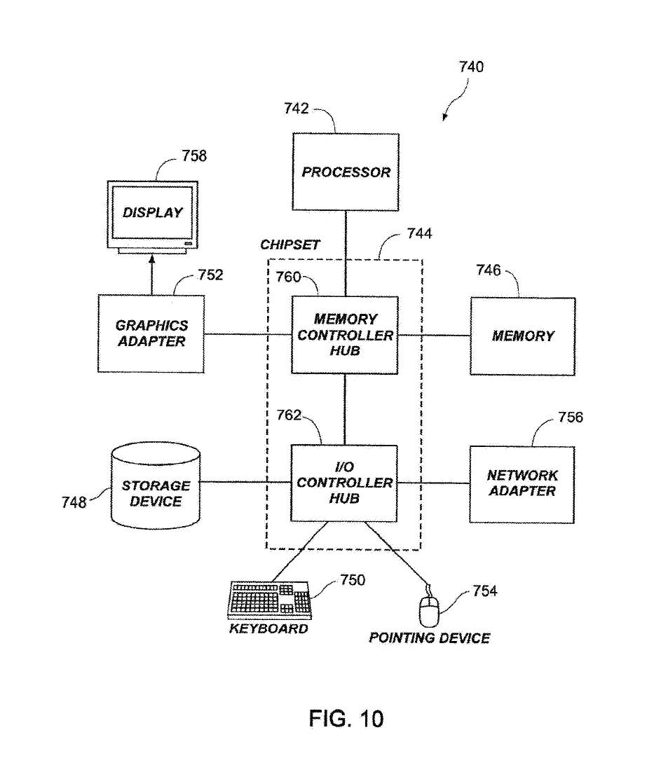

Referring to FIG. 10, a high-level block diagram of a computer system 740 for acting as a gaming system 600 (see FIGS. 8 and 9) according to one embodiment is shown. Illustrated are at least one processor 742 coupled to a chipset 744, as indicated in dashed lines. Also coupled to the chipset 744 are a memory 746, a storage device 748, a keyboard 750, a graphics adapter 752, a pointing device 754, and a network adapter 756. A display 758 is coupled to the graphics adapter 752. In one embodiment, the functionality of the chipset 744 is provided by a memory controller hub 760 and an I/O controller hub 762. In another embodiment, the memory 746 is coupled directly to the processor 742 instead of the chipset 744.

The storage device 748 is any non-transitory computer-readable storage medium, such as a hard drive, a compact disc read-only memory (CD-ROM), DVD, or a solid-state memory device (e.g., a flash drive). The memory 746 holds instructions and data used by the processor 742. The pointing device 754 may be a mouse, a track pad, a track ball, or other type of pointing device, and is used in combination with the keyboard 750 to input data into the computer system 740. The graphics adapter 752 displays images and other information on the display 758. The network adapter 756 couples the computer system 740 to a local or wide area network.

As is known in the art, a computer system 740 can have different and/or other components than those shown in FIG. 9. In addition, the computer system 740 can lack certain illustrated components. In one embodiment, a computer system 740 acting as a gaming system 700 lacks a keyboard 750, pointing device 754, graphics adapter 752, and/or display 758. Moreover, the storage device 748 can be local and/or remote from the computer system 740 (such as embodied within a storage area network (SAN)). Moreover, other input devices, such as, for example, touch screens may be included.

The network adapter 756 (may also be referred to herein as a communication device) may include one or more devices for communicating using one or more of the communication media and protocols discussed above with respect to FIG. 8.

In addition, some or all of the components of this general computer system 740 of FIG. 10 may be used as part of the processor and memory discussed above with respect to the systems of FIGS. 5, 6, and 7.

The gaming system 600 may comprise several such computer systems 740. The gaming system 600 may include load balancers, firewalls, and various other components for assisting the gaming system 600 to provide services to a variety of user devices.

As is known in the art, the computer system 740 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 748, loaded into the memory 746, and executed by the processor 742.

Embodiments of the entities described herein can include other and/or different modules than the ones described here. In addition, the functionality attributed to the modules can be performed by other or different modules in other embodiments. Moreover, this description occasionally omits the term “module” for purposes of clarity and convenience.

Some portions of the disclosure are presented in terms of algorithms (e.g., as represented in flowcharts, prose descriptions, or both) and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic, or optical signals capable of being stored, transferred, combined, compared, and otherwise manipulated. It is convenient at times, principally for reasons of common usage, to refer to these signals as bits, values, elements, symbols, characters, terms, numbers, or the like. Furthermore, it is also convenient at times to refer to certain arrangements of steps requiring physical manipulations or transformation of physical quantities or representations of physical quantities as modules or code devices, without loss of generality.

However, all of these and similar tennis are to be associated with the appropriate physical quantities and are merely convenient labels applied to these quantities. Unless specifically stated otherwise as apparent from the following discussion, it is appreciated that throughout the description, discussions utilizing terms such as “processing,” “computing,” “calculating,” “determining,” “displaying,” or the like, refer to the action and processes of a computer system, or similar electronic computing device (such as a specific computing machine), that manipulates and transforms data represented as physical (electronic) quantities within the computer system memories or registers or other such information storage, transmission or display devices.

Certain aspects of the embodiments include process steps and instructions described herein in the form of an algorithm. It should be noted that the process steps and instructions of the embodiments can be embodied in software, firmware, or hardware, and when embodied in software, could be downloaded to reside on and be operated from different platforms used by a variety of operating systems. The embodiments can also be in a computer program product, which can be executed on a computing system.

Some embodiments also relate to an apparatus for performing the operations herein. Such an apparatus may be specially constructed for the purposes, e.g., a specific computer, or it may comprise a general-purpose computer selectively activated or reconfigured by a computer program stored in the computer. Such a computer program may be stored in a computer-readable storage medium, such as, but is not limited to, any type of disk including floppy disks, optical disks, CD-ROMs, magnetic-optical disks, read-only memories (ROMs), random access memories (RAMS), EPROMs, EEPROMs, magnetic or optical cards, application specific integrated circuits (ASICs), or any type of media suitable for storing electronic instructions, and each coupled to a computer system bus. Memory can include any of the above and/or other devices that can store information/data/programs and can be a transient or non-transient medium, where a non-transient or non-transitory medium can include memory/storage that stores information for more than a minimal duration. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the method steps. The structure for a variety of these systems will appear from the description herein. In addition, the embodiments are not described with reference to any particular programming language. It will be appreciated that a variety of programming languages may be used to implement the teachings of the embodiments as described herein, and any references herein to specific languages are provided for the purposes of enablement and best mode.

Other game play and wagering variations may include:

### Three Card Monte

A casino game, played with 1-2-3-4-5-6-7 or 8 decks of the cards. After dealer shuffles the cards manually or in the shuffling devices, cards are placed in dealing shoe. Dealer draws 3 cards from the shoe and place them face down in the designated 3 marked position boxes on the table. As they are drawn from the shoe, cards are recognized by electronic card recognition technology. One second after last card is placed in designated position, one of 3 cards will be chosen by random number generator algorithm and displayed on the monitor visible to dealer and all players. [symbol] 1.

Players are placing a different bets based on one of 52 card value (similar to roulette). Deck of the cards has 52 cards and 2 Jokers, but for this game deck could have 4 Jokers (to increase casino edge).

Game could be played with 1 or more decks, with different payout rules, depending on different percentage of casino advantage and rules and regulations about maximum allowed casino advantages.

If Joker is the chosen card, all bets (except Joker Bet) will loose.

Bets:

1. Odd number-even number of the chosen card.

2. Red Suite-Black Suite.

3. Picture card.

4. Card with numerical value.

5. One of the 13 cards: A, 2, 3, 4, 5, 6, 7, 8, 9, 10, J, Q, K.

6. Repeated card—same card as from previous draw.

7. Pick the one (or two) of 3 designated area where 3 card will be placed after being withdraw.

8. Joker.
Dealer announces: “No more bets”, and draws 3 cards which are placed to 3 marked designated area on the table in front of the dealer. Cards can be drawn from: Smart Dealing Shoe, Shuffler, plain dealing shoe with camera over and IR panel in front of the shoe, plain dealing shoe and Camera over designated section where 3 cards are placed with 3 IR panels under each card position, plain dealing shoe with camera built under the section in front of the shoe or from plain dealing shoe without any card recognition technology used (in this case, dealer would manually turn the card face up).

A short time period after all 3 cards are placed in their designated area on the table, image of one (one of the 3) will appear on the table monitor visible to dealer and players. The target card will be chosen using computational random generator and displayed after being recognized by one of the above methods, by vote of players, by a single player selection, or any other random event method. With outcome of initial bets resolved, dealer will pay all bets on the table with some special exceptions, such as wagering before play of the round that a joker will be one of the cards.

Players can now place a second round of the bets, such as:

1. Which card of 3 cards on the table is the one displayed on the monitor.

2. Option to pick two cards.

Variations of the game and technology applied could be:

No card recognition system incorporated into the game. In this variation certain bets, such as bets numbers 6 and 7 and the second round of the bets may not exist.

Because of popularity of real street Monte, some well-known and comic elements—cheating and deceiving on the street could be incorporated into the for fun version, and if allowed, into the casino version.

For example the game could be called: “Catch the Cheat”, an option to pick two cards could be called “Cheat's Associate”, as when in the real Monte when associate flash (or mark) one of 3 cards to spectators behind cheater's back.

Besides being potential show case of newer automated or semi-automated gaming technology, the game is:

1. Simple to play.

2. Simple to learn for dealers.

3. Fast.

4. It has two rounds of betting for one dealers hand.

Alternative descriptions and variants within the generic concept of the present invention include at least a method for executing a wagering event on an electronic gaming machine including an electronic gaming system with at least a housing, a video display, a processor, memory, player input controls at at least one player position and a value-in-value-out credit creation component for entering credit into memory which can be used to place wagers through the player input controls selected from the group consisting of a) a ticket-in-ticket-out system having a ticket-reading scanner and ticket printer, b) a currency validation system having a motor drive to advance currency past a scanner, and c) a near field communication system comprising a sensor in the gaming system and a readable card, tag or key that can communicatively interact with the sensor in the electronic gaming machine, the memory containing executable software that enables implementation of the wagering event with steps that may include:
i) the electronic system recognizing at least the presence of a wager at the at least one player position;
ii) the processor identifying at least three virtual playing cards delivered from a virtual set of randomly provided virtual playing cards stored in memory;
iii) the at least three virtual playing cards being displayed on the video display according to an order of a first virtual playing card, a second virtual playing card and a third virtual playing card by which the randomly provided virtual playing cards are display as delivered a first virtual playing card position, a second virtual playing card position and a third virtual playing card position to the video display;
iv) the at least three virtual playing cards are delivered with only backs of the playing card shown on delivery of the first virtual playing card, the second virtual playing card and the third virtual playing card to their respective first virtual playing card position, second virtual playing card position and third virtual playing card position on the video display, with suit and/or rank of at least three different playing cards being displayed as suits and/or ranks of the at least three virtual playing cards delivered;
v) the at least one player position indicating by visible signal displayed on the video display a selection of which of the first playing card matches one of suit and/or rank of at least three different playing cards being displayed; and
vi) the at least one wager resolved by comparing the correspondence of the selection at the player position as to whether the first playing card, the second playing card or the third playing card matches the random playing card image randomly selected from among the suit and/or rank of at least three different playing cards being displayed and,
   wherein exact correspondence between the selection at the player position and the suit and/or rank of at least three different playing cards being displayed that has been selected results in a winning outcome for the at least one player position.

The method may be executed wherein an initial display of backs of the at least three virtual playing cards provided on the video display are shown in animation to interchange positions with each other.

The method may be executed wherein by input at the player position through player input controls, a first selection is made identifying one of the suit and/or rank of at least three different playing cards being displayed with either the first, second or third virtual playing card position, leaving at least two unselected virtual playing card positions and at least two unselected suits and/or ranks from the at least three different playing cards being displayed, and a second selection is made identifying one of the suit and/or rank from the at least two unselected suits and/or ranks at one of the at least unselected virtual playing card positions, and wherein exact correspondence between at least one of the two selections or virtual playing card suit and/or rank made at the player position with respect to the at two selected virtual playing card positions is used by the processor to resolve a winning outcome for the at least one player position.

An electronic gaming machine may be configured to execute a wagering event, the electronic gaming machine including a housing, a video display, a processor, memory, player input controls at at least one player position and a value-in-value-out credit creation component for entering credit into memory which can be used to place wagers through the player input controls selected from the group consisting of a) a ticket-in-ticket-out system having a ticket-reading scanner and ticket printer, b) a currency validation system having a motor drive to advance currency past a scanner, and c) a near field communication system comprising a sensor in the gaming system and a readable card, tag or key that can communicatively interact with the sensor in the electronic gaming machine, the memory containing executable software that enables implementation of the wagering event with steps including:
i) recognizing at least the presence of a wager at the at least one player position;
ii) the processor identifying at least three virtual playing cards delivered from a virtual set of randomly provided virtual playing cards stored in memory;
iii) the at least three virtual playing cards being displayed on the video display according to an order of a first virtual playing card, a second virtual playing card and a third virtual playing card by which the randomly provided virtual playing cards are display as delivered a first virtual playing card position, a second virtual playing card position and a third virtual playing card position to the video display;
iv) images of the at least three virtual playing cards are delivered with only backs of the playing card shown on the display screen on delivery of the first virtual playing card, the second virtual playing card and the third virtual playing card to their respective first virtual playing card position, second virtual playing card position and third virtual playing card position on the video display, with suit and/or rank of at least three different playing cards being displayed as suits and/or ranks of the at least three virtual playing cards delivered;
v) the at least one player position configured to enable indication by visible signal displayed on the video display a selection of which of the first playing card matches one of suit and/or rank of at least three different playing cards being displayed; and
vi) the at least one wager configured to be resolved by the processor by comparing the correspondence of the selection at the player position as to whether the first playing card, the second playing card or the third playing card matches the random playing card image randomly selected from among the suit and/or rank of at least three different playing cards being displayed and,
   wherein the processor is configured to resolve exact correspondence between the selection at the player position and the suit and/or rank of at least three different playing cards being displayed that has been selected results in a winning outcome for the at least one player position.

The electronic gaming system my further provide that the processor is configured to cause on the video display an initial display of backs of the at least three virtual playing cards provided that are shown in animation to interchange positions with each other, and then stop in a final first virtual playing card position, a final second virtual playing card position, and a final third virtual playing card position.

While certain illustrative embodiments have been described in connection with the figures, those of ordinary skill in the art will recognize and appreciate that embodiments encompassed by the disclosure are not limited to those embodiments explicitly shown and described herein. Rather, many additions, deletions, and modifications to the embodiments described herein may be made without departing from the scope of embodiments encompassed by the disclosure, such as those hereinafter claimed, including legal equivalents. In addition, features from one disclosed embodiment may be combined with features of another disclosed embodiment while still being within the scope of the disclosure, as contemplated by the inventor.

What is claimed:

1. A system for executing a wagering game comprising:
a. a gaming table;
b. a storage system for a set of randomly provided playing cards;
c. an automatic playing card reading system which identifies playing cards delivered from the set of randomly provided playing cards according to an order by which the randomly provided playing cards are delivered to the gaming table;
d. positions on the gaming table for receiving the randomly provided playing cards which are delivered to the gaming table;
e. at least one player position at the gaming table;
f. at least one wagering position on the gaming table for receiving wagers on the wagering game;
g. an electronic system associated with the at least one wagering position on the gaming table, the electronic system recognizing at least the presence of a wager at the at least one player position;
h. the automatic playing card reading system identifying at least three playing cards delivered from the set of randomly provided playing cards according to an order of a first playing card, a second playing card and a third playing card by which the randomly provided playing cards are delivered a first playing card position, a second playing card position and a third playing card position to the gaming table;
i. after delivery of the first playing card, the second playing card and the third playing card to their respective first playing card position, second playing card position and third playing card position at the gaming table, the automatic playing card reading system sends a command to a video display visible to the at least one player of a random playing card image randomly selected from the first playing card, the second playing card and the third playing card;
j. the at least one player position indicating by visible signal which of the first playing card, the second playing card and the third playing card matches the random playing card image randomly selected from the first playing card, the second playing card and the third playing card; and
k. the at least one wager resolved by comparing the correspondence of the indication at the player position as to whether the first playing card, the second playing card or the third playing card matches the random playing card image randomly selected,
wherein exact correspondence between the indication at the player position and the random playing card image randomly selected results in a winning outcome for the at least one player position.

2. The system of claim 1 wherein all playing cards are physical playing cards which are in the storage system, and the storage system comprises a system selected from the group consisting of a dealer shoe containing a randomized set of playing cards, an electromechanical shuffler which delivers individual random playing cards or a set of three random playing cards for physical removal from the system.

3. The system of claim 1 wherein the storage system comprises a dealer shoe having the automatic playing card reading system physically attached to the dealer shoe or located at a position at a playing card delivery end of the dealer shoe.

4. The system of claim 1 wherein the storage system comprises a dealer shoe having the automatic playing card reading system comprising a code reading component which identifies a code on the delivery shoe and transmits that code to a processor as a component of the automatic playing card reading system.

5. The system of claim 1 wherein the storage system comprises an electromechanical playing card shuffler having the automatic playing card reading system physically attached to the electromechanical playing card shuffler or located at a position at a playing card delivery end of the electromechanical playing card shuffler.

6. The system of claim 1 wherein the electronic system associated with the at least one player position comprises an electronic wagering system that recognizes at least the presence of at least one wager at the at least one player position as a wager on a correspondence outcome selected from the group consisting of:
A. An odd versus even rank of the random playing card image randomly selected from the first playing card, the second playing card and the third playing card;
B. An outcome of one of two specific colors available for a first color versus second color wager;
C. An outcome wager of a first subset of ranked cards versus a second subset of ranked cards; one or two positions from among the first playing card position, the second playing card position and the third playing card position; and
D. A wager that the random playing card image randomly selected is a special card and not a playing card within a standard 52-card playing card deck.

7. The system of claim 6 wherein the electronic system associated with the at least one player position is a player input panel in communication with a processor that causes placed wagers to be displayed on the player input panel.

8. A method for executing a wagering event on an electronic gaming machine comprising an electronic gaming system with at least a housing, a video display, a processor, memory, player input controls at at least one player position and a value-in-value-out credit creation component for entering credit into memory which can be used to place wagers through the player input controls selected from the group consisting of a) a ticket-in-ticket-out system having a ticket-reading scanner and ticket printer, b) a currency validation system having a motor drive to advance currency past a scanner, and c) a near field communication system comprising a sensor in the gaming system and a readable card, tag or key that can communicatively interact with the sensor in the electronic gaming machine, the memory containing executable software that enables implementation of the wagering event with steps comprising:
1. the electronic system recognizing at least the presence of a wager at the at least one player position;
2. the processor identifying at least three virtual playing cards delivered from a virtual set of randomly provided virtual playing cards stored in memory;
3. the at least three virtual playing cards being displayed on the video display according to an order of a first virtual playing card, a second virtual playing card and a third virtual playing card by which the randomly provided virtual playing cards are display as delivered a first virtual playing card position, a second virtual playing card position and a third virtual playing card position to the video display;
4. the at least three virtual playing cards are delivered with only backs of the playing card shown on delivery of the first virtual playing card, the second virtual playing card and the third virtual playing card to their respective first virtual playing card position, second virtual playing card position and third virtual playing card position on the video display, with suit and/or rank of at least three different playing cards being displayed as suits and/or ranks of the at least three virtual playing cards delivered;
5. the at least one player position indicating by visible signal displayed on the video display a selection of which of the first playing card matches one of suit and/or rank of at least three different playing cards being displayed; and
6. the at least one wager resolved by comparing the correspondence of the selection at the player position as to whether the first playing card, the second playing card or the third playing card matches the random playing card image randomly selected from among the suit and/or rank of at least three different playing cards being displayed and,
wherein exact correspondence between the selection at the player position and the suit and/or rank of at least three different playing cards being displayed that has been selected results in a winning outcome for the at least one player position.

9. The method of claim 8 wherein an initial display of backs of the at least three virtual playing cards provided on the video display are shown in animation to interchange positions with each other.

10. The method of claim 8 wherein by input at the player position through player input controls, a first selection is made identifying one of the suit and/or rank of at least three different playing cards being displayed with either the first, second or third virtual playing card position, leaving at least two unselected virtual playing card positions and at least two unselected suits and/or ranks from the at least three different playing cards being displayed, and a second selection is made identifying one of the suit and/or rank from the at least two unselected suits and/or ranks at one of the at least unselected virtual playing card positions, and wherein exact correspondence between at least one of the two selections or virtual playing card suit and/or rank made at the player position with respect to the at two selected virtual playing card positions is used by the processor to resolve a winning outcome for the at least one player position.

11. The method of claim 10 wherein exact correspondence between both of the two selections or virtual playing card suit and/or rank made at the virtual player position with respect to the at two selected virtual playing card positions is used by the processor to resolve a winning outcome for the at least one player position.

12. The method of claim 9 wherein by input at the player position through player input controls, a first selection is made identifying one of the suit and/or rank of at least three different playing cards being displayed with either the first, second or third virtual playing card position, leaving at least two unselected virtual playing card positions and at least two unselected suits and/or ranks from the at least three different playing cards being displayed, and a second selection is made identifying one of the suit and/or rank from the at least two unselected suits and/or ranks at one of the at least unselected virtual playing card positions, and wherein exact correspondence between at least one of the two selections or virtual playing card suit and/or rank made at the player position with respect to the at two selected virtual playing card positions is used by the processor to resolve a winning outcome for the at least one player position.

13. The method of claim 12 wherein exact correspondence between both of the two selections or virtual playing card suit and/or rank made at the virtual player position with respect to the at two selected virtual playing card positions is used by the processor to resolve a winning outcome for the at least one player position

14. An electronic gaming machine configured to execute a wagering event, the electronic gaming machine comprising a housing, a video display, a processor, memory, player input controls at at least one player position and a value-in-value-out credit creation component for entering credit into memory which can be used to place wagers through the player input controls selected from the group consisting of a) a ticket-in-ticket-out system having a ticket-reading scanner and ticket printer, b) a currency validation system having a motor drive to advance currency past a scanner, and c) a near field communication system comprising a sensor in the gaming system and a readable card, tag or key that can communicatively interact with the sensor in the electronic gaming machine, the memory containing executable software that enables implementation of the wagering event with steps comprising:
i) recognizing at least the presence of a wager at the at least one player position;
ii) iv) the processor identifying at least three virtual playing cards delivered from a virtual set of randomly provided virtual playing cards stored in memory;
iii) the at least three virtual playing cards being displayed on the video display according to an order of a first virtual playing card, a second virtual playing card and a third virtual playing card by which the randomly provided virtual playing cards are display as delivered a first virtual playing card position, a second virtual playing card position and a third virtual playing card position to the video display;
iv) images of the at least three virtual playing cards are delivered with only backs of the playing card shown on the display screen on delivery of the first virtual playing card, the second virtual playing card and the third virtual playing card to their respective first virtual playing card position, second virtual playing card position and third virtual playing card position on the video display, with suit and/or rank of at least three different playing cards being displayed as suits and/or ranks of the at least three virtual playing cards delivered;
v) the at least one player position configured to enable indication by visible signal displayed on the video display a selection of which of the first playing card matches one of suit and/or rank of at least three different playing cards being displayed; and
vi) the at least one wager configured to be resolved by the processor by comparing the correspondence of the selection at the player position as to whether the first playing card, the second playing card or the third playing card matches the random playing card image randomly selected from among the suit and/or rank of at least three different playing cards being displayed and,
wherein the processor is configured to resolve exact correspondence between the selection at the player position and the suit and/or rank of at least three different playing cards being displayed that has been selected results in a winning outcome for the at least one player position.

15. The electronic gaming system of claim 14 wherein the processor is configured to cause on the video display an initial display of backs of the at least three virtual playing cards provided that are shown in animation to interchange positions with each other, and then stop in a final first virtual playing card position, a final second virtual playing card position, and a final third virtual playing card position.

16. The electronic gaming machine of claim 14 herein the processor is configured to identify and execute game code of input at the player position through player input controls, a first selection being made identifying one of the suit and/or rank of at least three different playing cards being displayed with either the first, second or third virtual playing card position, leaving at least two unselected virtual playing card positions and at least two unselected suits and/or ranks from the at least three different playing cards being displayed, and a second selection being made identifying one of the suit and/or rank from the at least two unselected suits and/or ranks at one of the at least unselected virtual playing card positions, and wherein exact correspondence between at least one of the two selections or virtual playing card suit and/or rank made at the player position with respect to the at two selected virtual playing card positions is used by the processor to resolve a winning outcome for the at least one player position.

17. The electronic gaming machine of claim 16 wherein exact correspondence between both of the two selections or virtual playing card suit and/or rank made at the virtual player position with respect to the at two selected virtual playing card positions is used by the processor to resolve a winning outcome for the at least one player position.
